(19) United States
(12) Patent Application Publication
(10) Pub. No.: US 2026/0301014 A1
(43) Pub. Date: Oct. 1, 2026

(54) REAL-TIME DATA QUALITY ASSURANCE BY INTEGRATING AI-DRIVEN ANOMALY DETECTION, EXPLAINABLE AI, AND AUTOMATED ROOT CAUSE ANALYSIS FOR SUPERIOR DATA QUALITY IN THE ETL PIPELINES

(71) Applicant: Dell Products L.P., Round Rock, TX (US)

(72) Inventors: Dinesh Koppada, Bengaluru (IN); Furkan Mohd Nisar, Ambedkar Nagar (IN); Vivek Bhargava, Bangalore (IN); Amarendra Chowdary Muppalaneni, Plano, TX (US)

(73) Assignee: Dell Products L.P., Round Rock, TX (US)

(21) Appl. No.: 19/090,553

(22) Filed: Mar. 26, 2025

(51) Int. Cl. G06Q 30/0201; G06F 16/25

(52) U.S. Cl. CPC G06Q 30/0206; G06F 16/254

(57) ABSTRACT

Methods, system, and non-transitory processor-readable storage medium for an ETL anomaly detection system are provided herein. An example method includes receiving, by an Extract, Transform, Load (ETL) anomaly detection system, source data for processing through an ETL pipeline. The ETL anomaly detection system detects anomalies in the source data using a trained machine learning model. The ETL anomaly detection system analyzes the detected anomalies using Shapley Additive Explanations (SHAP) values to determine contributing factors to the anomalies. The ETL anomaly detection system validates quality of the source data based on the detected anomalies and SHAP analysis. The ETL anomaly detection system loads validated data into a target system while maintaining application continuity.

### FIELD

The field relates generally to detecting anomalies within Extract, Transform, and Load pipelines, within information processing systems.

### BACKGROUND

An Extract, Transform, Load (ETL) pipeline is a set of processes that move data from a source system to a target system.

### SUMMARY

Illustrative embodiments provide techniques for implementing an Extract, Transform, Load (ETL) anomaly detection system in a storage system. For example, illustrative embodiments receive source data for processing through an ETL pipeline. The ETL anomaly detection system detects anomalies in the source data using a trained machine learning model. The ETL anomaly detection system analyzes the detected anomalies using Shapley Additive Explanations (SHAP) values to determine contributing factors to the anomalies. The ETL anomaly detection system validates the quality of the source data based on the detected anomalies and SHAP analysis, and loads the validated data into a target system while maintaining application continuity. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 illustrates an information processing system including an ETL anomaly detection system, in an illustrative embodiment.

FIG. 2 illustrates a flow diagram of a process for an ETL anomaly detection system, in an illustrative embodiment.

FIG. 3 illustrates an example of historical sales data, in an illustrative embodiment.

FIG. 4 illustrates an example of new sales data, in an illustrative embodiment.

FIG. 5 illustrates the SHAP values for new sales data, in an illustrative embodiment.

FIG. 6 illustrates a process flow for an ETL anomaly detection system, in an illustrative embodiment.

FIGS. 7 and 8 show examples of processing platforms that may be utilized to implement at least a portion of an ETL anomaly detection system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing an ETL anomaly detection system, which technique may be used to improve data quality control within ETL pipelines. The ETL anomaly detection system receives source data for processing through an ETL pipeline. The ETL anomaly detection system detects anomalies in the source data using a trained machine learning model. The ETL anomaly detection system analyzes the detected anomalies using Shapley Additive Explanations (SHAP) values to determine contributing factors to the anomalies. The ETL anomaly detection system validates the quality of the source data based on the detected anomalies and SHAP analysis, and loads the validated data into a target system while maintaining application continuity.

Data quality issues in source data originating from a source system can have a major impact on the data management process, especially during Extract, Transform, Load (ETL) processes. Applications and processes that rely on data from the target system can be affected if tampered with or incorrect data is sent from the source system to the target system. This can result in inaccurate results, faulty analysis, and poor decision-making, which can impact corporate operations and outcomes.

Conventional technologies validate data post-load (i.e., in the target system) within an ETL pipeline, resulting in a less efficient processes. Conventional technologies fail to ensure that only high-quality data is loaded into the target system, allowing data quality issues to propagate. Conventional technologies base their analytics, reporting, and business intelligence on target systems, resulting in inaccurate reports, misleading patterns, and faulty business insights from the low-quality data in the target systems, ultimately impacting operational effectiveness and strategic choices. Conventional technologies running applications that depend on data from target systems encounter system crashes, incorrect data output, and customer dissatisfaction when the data in the target systems encounter errors, inaccuracies, and data integrity problems. Conventional technologies that encounter data quality issues in their target systems experience additional costs and increased use of significant resources for manual data correction, troubleshooting and cleaning.

By contrast, in at least some implementations in accordance with the current technique as described herein, the improvement in data quality control within ETL pipelines is achieved by an ETL anomaly detection system that receives source data for processing through the ETL pipeline. The ETL anomaly detection system detects anomalies in the source data using a trained machine learning model. The ETL anomaly detection system analyzes the detected anomalies using Shapley Additive Explanations (SHAP) values to determine contributing factors to the anomalies. The ETL anomaly detection system validates the quality of the source data based on the detected anomalies and SHAP analysis, and loads the validated data into a target system while maintaining application continuity.

Thus, a goal of the current technique is to provide a method and a system for an ETL anomaly detection system that maintains high quality data while efficiently gathering data from various data sources into a centralized warehouse and/or data lake. Another goal is to create a self-learning, intelligent system that identifies and handles data quality issues in real-time to guarantee data reliability, consistency, and integrity across various datasets. Another goal is to combine AI-driven detection, integration of Explainable AI with real-time in-pipeline monitoring with an Extract, Transform, and Load system to maintain application continuity. Another goal is to provide a solution that employs SHAP values to automatically analyze the root causes of anomalies in addition to detecting the anomalies, reducing the manual work needed for root cause analysis. Another goal is to examine past data to identify specific trends and establish expected thresholds for key indicators by performing statistical analysis and establish baseline metrics models. Another goal is to identify anomalies in incoming data and apply machine learning models to track data in real-time within an ETL pipeline. Another goal is to define data quality rules, evaluate data properties, categories and patterns against the data quality rules to validate the data against specific requirements and expectations. Yet another goal is to provide real-time data quality monitoring, create boundaries and rules to notify stakeholders of any anomalies.

In at least some implementations in accordance with the current technique described herein, the use of an ETL anomaly detection system can provide one or more of the following advantages: detects anomalies in the new data while applications on the target system continue to operate on previously verified data, ensuring stability and continuity of business operations, provides an intelligent, self-learning system that automatically detects and handles data quality issues in real-time using AI and machine learning, provides a self-healing and alerting mechanism for any data-related anomaly, provides real-time anomaly detection within an ETL pipeline, proactively identifies anomalies before data is loaded into the target system, provides an innovate application for SHAP for Explainable AI in the ETL pipeline process, providing an understanding of the justification for marking incoming data as anomalous, provides transparent anomaly detection allowing stakeholders to diagnose and resolve problems more easily, and provides data reliability, consistency, and integrity across various datasets.

In contrast to conventional technologies, in at least some implementations in accordance with the current technique as described herein, the improvement of data quality control within ETL pipelines is achieved by an ETL anomaly detection system that receives source data for processing through the ETL pipeline. The ETL anomaly detection system detects anomalies in the source data using a trained machine learning model. The ETL anomaly detection system analyzes the detected anomalies using Shapley Additive Explanations (SHAP) values to determine contributing factors to the anomalies. The ETL anomaly detection system validates the quality of the source data based on the detected anomalies and SHAP analysis, and loads the validated data into a target system while maintaining application continuity.

In an example embodiment of the current technique, the ETL anomaly detection system generates visual representations of SHAP values to explain anomaly detection decisions.

In an example embodiment of the current technique, the ETL anomaly detection system generates alerts when anomalies are detected.

In an example embodiment of the current technique, the ETL anomaly detection system extracts historical data from the target system to train the trained machine learning model.

In an example embodiment of the current technique, the ETL anomaly detection system preprocesses the source data to match a format used for training the trained machine learning model.

In an example embodiment of the current technique, the trained machine learning model comprises a Random Forest classifier trained on the historical data.

In an example embodiment of the current technique, the ETL anomaly detection system feature engineers on the historical data prior to training the trained machine learning model.

In an example embodiment of the current technique, the ETL anomaly detection system calculates average prices by product model and determines price deviations from the average.

In an example embodiment of the current technique, the trained machine learning model comprises a Random Forest classifier with multiple decision trees, a feature engineering pipeline that calculates average prices by product model and price deviations, a probability threshold of 0.5 for anomaly classification, and risk level categorization based on probability scores above 0.75 for high risk and between 0.5-0.75 for medium risk.

In an example embodiment of the current technique, the ETL anomaly detection system generates features that capture patterns in the data, calculates probability scores for anomaly detection, and compares the probability scores against defined thresholds to identify anomalies.

In an example embodiment of the current technique, the ETL anomaly detection system calculates average values and deviations for numerical data fields.

In an example embodiment of the current technique, the ETL anomaly detection system uses the trained machine learning model's probability output to determine likelihood of anomalies.

In an example embodiment of the current technique, the defined thresholds classify anomalies into risk levels comprising low, medium and high risk.

In an example embodiment of the current technique, the ETL anomaly detection system initializes a TreeExplainer for the Random Forest model, calculates SHAP values for each feature in the anomalous record, generates force plots showing feature-level contributions, and creates summary plots visualizing overall feature impacts on the model output.

In an example embodiment of the current technique, the ETL anomaly detection system calculates SHAP values to determine relative contribution of each feature to anomaly detection.

In an example embodiment of the current technique, the ETL anomaly detection system calculates feature importance rankings from the Random Forest model, analyzes SHAP values to determine feature contributions, compares anomalous values against historical patterns, and identifies specific attributes and thresholds that triggered the anomaly.

In an example embodiment of the current technique, the ETL anomaly detection system compares patterns in the source data against patterns learned from the historical data.

In an example embodiment of the current technique, the ETL anomaly detection system allows applications to operate on previously validated data while new data is being processed.

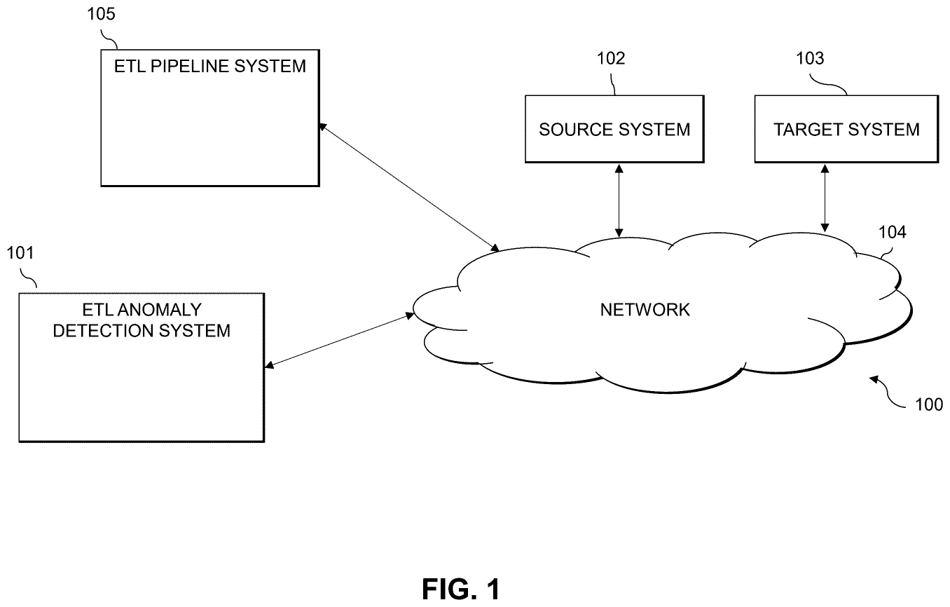

FIG. 1 shows a computer network (also referred to herein as an information processing system) 100 configured in accordance with an illustrative embodiment. The computer network 100 comprises an ETL anomaly detection system 101, an ETL pipeline system 105, a source system 102 and a target system 103. The ETL anomaly detection system 101, ETL pipeline system 105, source system 102 and target system 103 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The ETL anomaly detection system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the ETL anomaly detection system 101, ETL pipeline system 105, source system 102 and target system 103 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The ETL anomaly detection system 101, ETL pipeline system 105, source system 102 and target system 103 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the ETL anomaly detection system 101 are one or more input-output devices, which illustratively comprise keyboards, displays or other types of input-output devices in any combination. Such input-output devices can be used, for example, to support one or more user interfaces to the ETL anomaly detection system 101, as well as to support communication between the ETL anomaly detection system 101 and other related systems and devices not explicitly shown. For example, a dashboard may be provided for a user to view results produced by the ETL anomaly detection system 101. One or more input-output devices may also be associated with any of the ETL pipeline system 105, source system 102 and target system 103.

Additionally, the ETL anomaly detection system 101 in the FIG. 1 embodiment is assumed to be implemented using at least one processing device. Each such processing device generally comprises at least one processor and an associated memory, and implements one or more functional modules for controlling certain features of the ETL anomaly detection system 101.

More particularly, the ETL anomaly detection system 101 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the ETL anomaly detection system 101 to communicate over the network 104 with the ETL pipeline system 105, source system 102 and target system 103 and illustratively comprises one or more conventional transceivers.

An ETL anomaly detection system 101 may be implemented at least in part in the form of software that is stored in memory and executed by a processor, and may reside in any processing device. The ETL anomaly detection system 101 may be a standalone plugin that may be included within a processing device.

It is to be understood that the particular set of elements shown in FIG. 1 for ETL anomaly detection system 101 involving the ETL anomaly detection system 101, ETL pipeline system 105, source system 102 and target system 103 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the ETL anomaly detection system 101 can be on and/or part of the same processing platform.

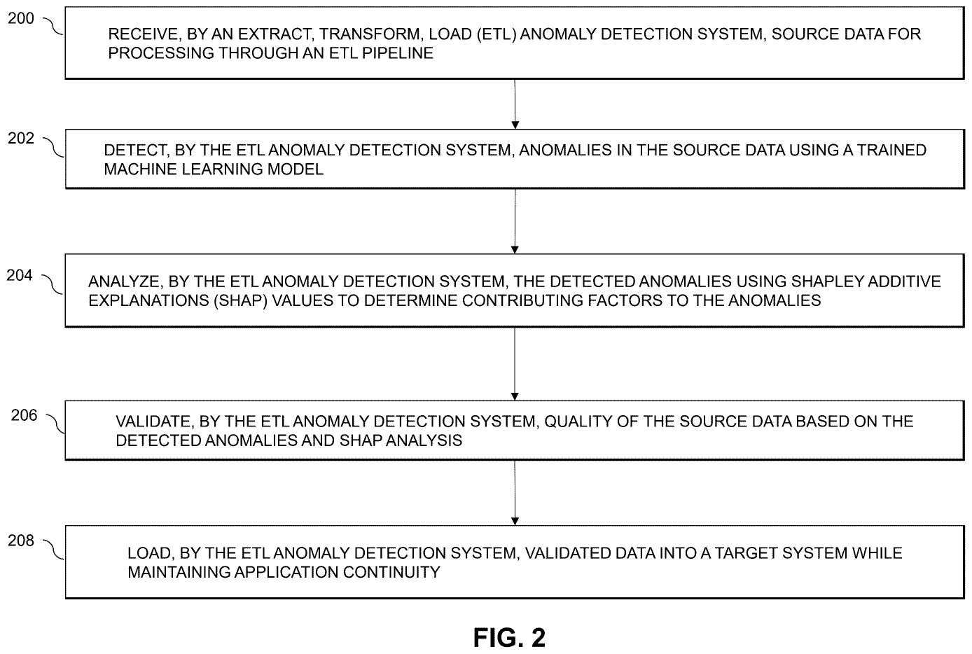

An exemplary process of ETL anomaly detection system 101 in computer network 100 will be described in more detail with reference to, for example, the flow diagram of FIG. 2.

FIG. 2 is a flow diagram of a process for execution of the ETL anomaly detection system 101 in an illustrative embodiment. It is to be understood that this particular process is only an example, and additional or alternative processes can be carried out in other embodiments.

At 200, the ETL anomaly detection system 101 receives source data for processing through an ETL pipeline system 105. At 202, the ETL anomaly detection system 101 detects anomalies in the source data using a trained machine learning model. In an example embodiment, before the source data is fed into the target system 103, the trained machine learning model is applied to newly received data to detect any anomalies and/or deviations. In an example embodiment, the ETL anomaly detection system 101 uses a trained machine learning model that is trained on historical data to instantly identify anomalies from the received source data. In an example embodiment, the ETL pipeline system 105 preprocesses the source data to match the format used for training the trained machine learning model. As new data flows through the ETL pipeline system 105, the ETL anomaly detection system 101 preprocesses the source data in the same way the historical data from the target system 103 is preprocessed. The new source data is passed through the target system 103 (i.e., the trained Random Forest model) to predict whether each record is an anomaly, based on the target system 103 learned patterns. As each record in the new source data flows through the ETL pipeline system 105, the ETL anomaly detection system 101 processes the record using the trained machine learning model to detect if a record is anomalous. The ETL anomaly detection system 101 produces a probability score.

In an example embodiment, the trained machine learning model is a Random Forest model. The Random Forest model's “feature_importances” property/attribute is used to determine which features have the most influence on the choice after the ETL anomaly detection system 101 identifies the anomaly. This provides an overview of the factors that influence the Random Forest model's decisions.

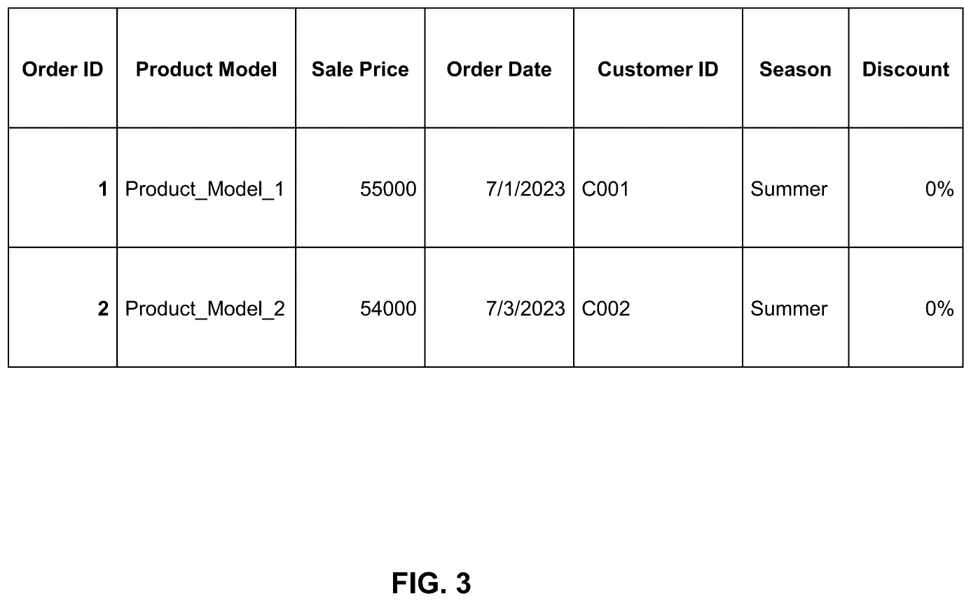

In an example embodiment, the ETL pipeline system 105 extracts historical data from the target system 103 to train the trained machine learning model. FIG. 3 illustrates an example of historical sales data. In an example embodiment, the trained machine learning model is a Random Forest classifier trained with historical data from the target system 103 as a baseline. The historical data from the target system 103 is used to train the trained machine learning model because this dataset has already been verified and is clean, allowing the trained machine learning model to train on comprehending “normal” behavior in the dataset. The dataset of “normal” behavior teaches the Random Forest classifier common patterns and boundaries, enabling the Random Forest classifier to identify future deviations as anomalies. In an example embodiment, during the training of the trained machine learning model, the historical data is labeled as “normal” since the historical data represents high-quality records in the target system 103.

In an example embodiment, the trained machine learning model comprises a Random Forest classifier with multiple decision trees, a feature engineering pipeline that calculates average prices by product model and price deviations, a probability threshold of 0.5 for anomaly classification, and risk level categorization based on probability scores above 0.75 for high risk and between 0.5-0.75 for medium risk. In an example embodiment, the ETL anomaly detection system 101 calculates the probability of each record being an anomaly using the target system 103's probability output. The ETL anomaly detection system 101 sets thresholds to group records, according to varying degrees of risk, such as low, medium, and high. In an example embodiment, the trained machine learning model predicts the probability that a feature is an anomaly. The ETL pipeline system 105 sets the probability threshold and the risk level categorization. In an example embodiment, the ETL anomaly detection system 101 reports out if an anomaly was detected and a percentage of confidence in that detected anomaly. In an example embodiment, the risk level may be categorized as “medium” or “high”.

In an example embodiment, the ETL anomaly detection system 101 feature engineers on the historical data prior to training the trained machine learning model. Feature engineering is a machine learning technique that leverages data to create new variables that aren't in the training set. In an example embodiment, the ETL anomaly detection system 101 creates features that capture essential patterns in the historical data, such as average selling price, per product model, price deviations, seasonal trends, and other relevant metrics. In an example embodiment, the ETL anomaly detection system 101 calculates average values and deviations for numerical data fields.

In an example embodiment, the ETL anomaly detection system 101 calculates probability scores for anomaly detection, and then compares the probability scores against defined thresholds to identify anomalies. In an example embodiment, the ETL anomaly detection system 101 uses the trained machine learning model's probability output to determine likelihood of anomalies. In an example embodiment, the defined thresholds classify anomalies into risk levels comprising low, medium and high risk. In an example embodiment, the ETL anomaly detection system 101 calculates average prices by product model and determines price deviations from the average.

In an example embodiment, the ETL anomaly detection system 101 generates alerts when anomalies are detected. In an example embodiment, the ETL anomaly detection system 101 may trigger a real-time alert to notify stakeholders, and/or quarantine the data. If no anomalies are detected, the ETL anomaly detection system 101 reports out that the “Order is normal” and proceeds to load the data received from the source system 102 into the target system 103.

At 204, the ETL anomaly detection system 101 analyzes the detected anomalies using Shapley Additive Explanations (SHAP) values to determine contributing factors to the anomalies. In an example embodiment, the ETL anomaly detection system 101 initializes a TreeExplainer for the Random Forest model.

In an example embodiment, the ETL anomaly detection system 101 calculates SHAP values for each feature in the anomalous record. In an example embodiment, the ETL anomaly detection system 101 calculates SHAP values to determine relative contribution of each feature to anomaly detection (i.e., how each variable affects the prediction of the Random Forest model).

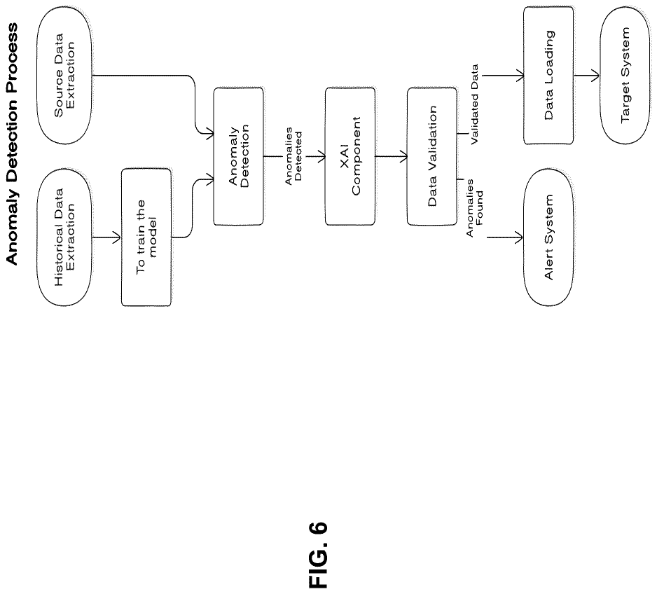

In an example embodiment, the Random Forest model identifies abnormalities in the new source data. Integrating Explainable AI (XAI) through SHAP into the ETL anomaly detection system 101 assists in comprehending the reasons behind why the ETL anomaly detection system 101 flagged specific records as anomalies. The SHAP values provide a deeper analysis of the contribution of each aspect in classifying the record as abnormal. To explain individual predictions, the ETL anomaly detection system 101 utilizes SHAP values to show the relative contribution of each feature to the trained machine learning model's conclusions for a given record. SHAP assigns the output of the trained machine learning model to the SHAP input features, providing an integrated measure of feature relevance and aiding in the interpretation of individual predictions. Thus, after the ETL anomaly detection system 101 detects anomalies, the new data is passed through the XAI component to generate and provide explanations as illustrated in FIG. 6.

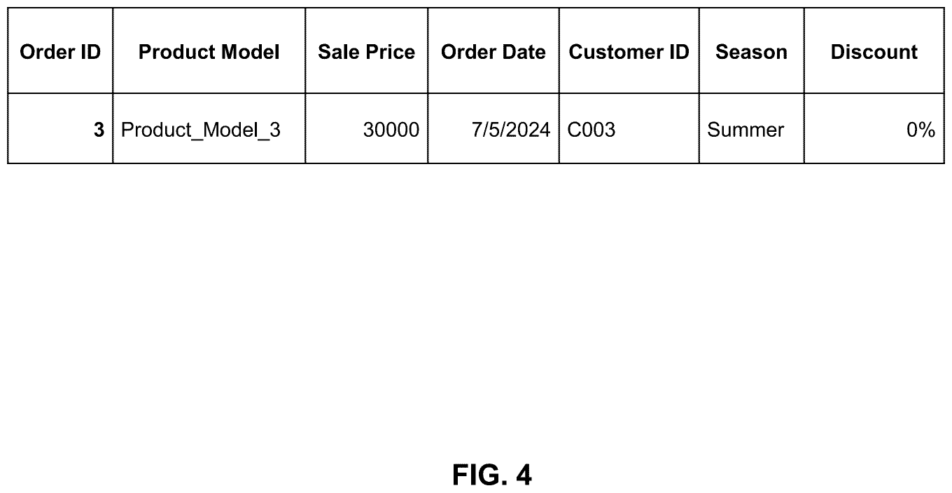

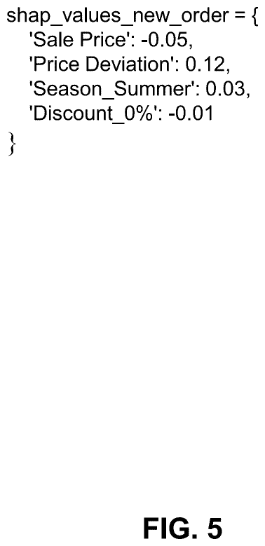

In an example embodiment, the ETL anomaly detection system 101 generates visual representations of SHAP values to explain anomaly detection decisions. The ETL anomaly detection system 101 generates force plots showing feature-level contributions, and creates summary plots visualizing overall feature impacts on the model output. In an example embodiment, the ETL anomaly detection system 101 provides a visual representation of the effect of each attribute (i.e., sales prices, season, etc. as illustrated in FIG. 3) via a SHAP force plot and summary plot. FIG. 4 illustrates an example of new sales data. In this example embodiment, the SHAP force plot indicates that the selling price of $30,000 is unusually low, and this feature had the greatest impact on the trained machine learning model identifying this order as unusual. The SHAP values highlight the attributes (such as price, date, discount, etc.) that have the most impact on the anomaly detected by the ETL anomaly detection system 101. The ETL anomaly detection system 101 analyzes the SHAP values and compares them with the historical data to identify the underlying cause of the anomaly. The other features, such as “Season” and “Discount” had less of an impact on the trained machine learning model identifying this order as unusual. FIG. 5 illustrates the SHAP values for the new sales order in FIG. 4. As illustrated in FIG. 5, the SHAP value for “Sale Price” is −0.05. A negative SHAP value indicates that the trained machine learning model's prediction is pushed away from normal by a lower sales price in comparison to typical prices.

In an example embodiment, the ETL anomaly detection system 101 calculates feature importance rankings from the Random Forest model. In an example embodiment, the ETL anomaly detection system 101 analyzes SHAP values to determine feature contributions. In an example embodiment, the ETL anomaly detection system 101 compares anomalous values against historical patterns, and identifies specific attributes and thresholds that triggered the anomaly.

At 206, the ETL anomaly detection system 101 validates the quality of the source data based on the detected anomalies and SHAP analysis. The ETL anomaly detection system 101 validates the new data before the new data reaches the target system 103 within the ETL pipeline system 105. In an example embodiment, the ETL anomaly detection system 101 compares patterns in the source data against patterns learned from the historical data. In an example embodiment, prior to the source data reaching the target system 103, the ETL pipeline system 105 detects deviations from known patterns and flags unusual or incorrect data entries. As illustrated in FIG. 6, the ETL anomaly detection system 101 integrates anomaly detection and XAI into a ETL pipeline system 105 by leveraging historical data from the target system 103 to train the trained machine learning model, and then calls XAI as a service during the ETL process.

At 208, the ETL anomaly detection system 101 loads validated data into a target system 103 while maintaining application continuity. Maintaining application continuity comprises allowing applications to operate on previously validated data while new data is being processed. While historical data is extracted from the target system 103 to train the trained machine learning model, real-time data is extracted from the source system 102 for processing.

The above-described illustrative embodiments provide significant advantages relative to conventional approaches. For example, some embodiments are configured to significantly optimize validating incoming data in real-time within an ETL pipeline. These and other embodiments can effectively improve detecting anomalies in the new data while applications on the target system continue to operate on previously verified data, ensuring stability and continuity of business operations. Embodiments disclosed herein provide an intelligent, self-learning system that automatically detects and handles data quality issues in real-time using AI and machine learning. Embodiments disclosed herein provide a self-healing and alerting mechanism for any data-related anomaly. Embodiments disclosed herein provide real-time anomaly detection within an ETL pipeline. Embodiments disclosed herein proactively identify anomalies before data is loaded into the target system. Embodiments disclosed herein provide an innovate application for SHAP for Explainable AI in the ETL pipeline process, providing an understanding of the justification for marking incoming data as anomalous. Embodiments disclosed herein provide transparent anomaly detection allowing stakeholders to diagnose and resolve problems more easily. Embodiments disclosed herein provide data reliability, consistency, and integrity across various datasets.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

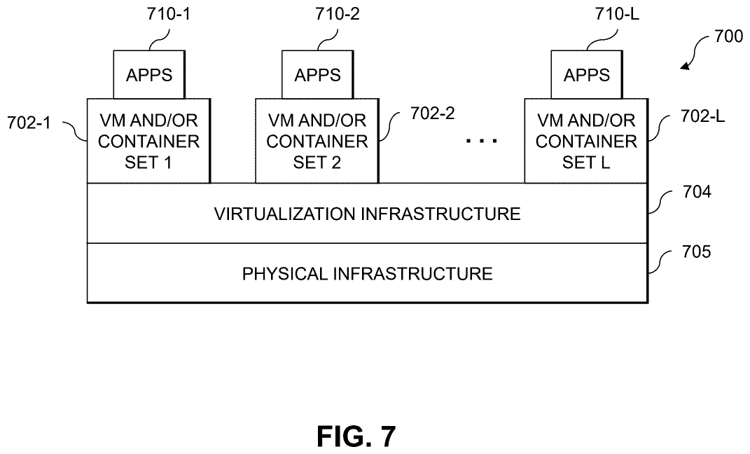

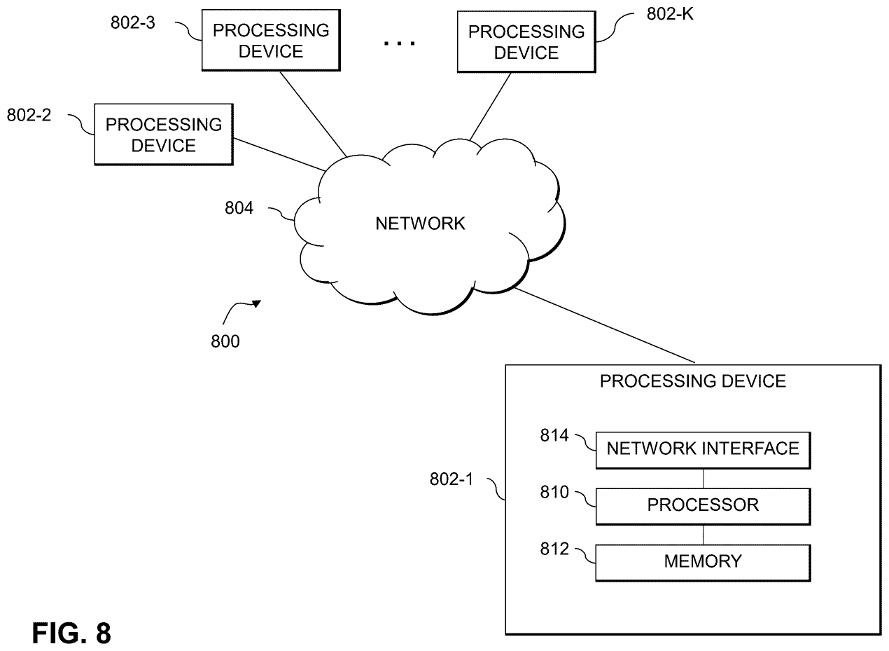

Illustrative embodiments of processing platforms will now be described in greater detail with reference to FIGS. 7 and 8. Although described in the context of the information processing system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, where the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of the information processing system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by an Extract, Transform, Load (ETL) anomaly detection system, source data for processing through an ETL pipeline;
detecting, by the ETL anomaly detection system, anomalies in the source data using a trained machine learning model, wherein the trained machine learning model comprises a Random Forest classifier with multiple decision trees, a feature engineering pipeline that calculates average prices by product model and price deviations, a probability threshold of 0.5 for anomaly classification, and risk level categorization based on probability scores above 0.75 for high risk and between 0.5-0.75 for medium risk;
analyzing, by the ETL anomaly detection system, the detected anomalies using Shapley Additive Explanations (SHAP) values to determine contributing factors to the anomalies;
validating, by the ETL anomaly detection system, quality of the source data based on the detected anomalies and SHAP analysis, wherein validating the quality of the source data based on the detected anomalies and SHAP analysis occurs before the source data reaches the target system; and
loading, by the ETL anomaly detection system, validated data into a target system while maintaining application continuity, and wherein, when anomalies are detected, data is quarantined rather than loaded into the target system, wherein the method is implemented by at least one processing device comprising a processor coupled to a memory.

2. The method of claim 1 further comprising generating visual representations of SHAP values to explain anomaly detection decisions.

3. The method of claim 1 further comprising:
generating alerts when anomalies are detected.

4. The method of claim 1 wherein detecting anomalies in the source data comprises:
extracting historical data from the target system to train the trained machine learning model.

5. The method of claim 1 wherein detecting anomalies in the source data comprises:
preprocessing the source data to match a format used for training the trained machine learning model.

6. The method of claim 1 wherein the trained machine learning model comprises a Random Forest classifier trained on the historical data.

7. The method of claim 6 further comprising:
feature engineering on the historical data prior to training the trained machine learning model.

8. The method of claim 7 wherein feature engineering comprises:
calculating average prices by product model; and
determining price deviations from the average.

9. (canceled)

10. The method of claim 1 wherein detecting anomalies in the source data comprises:
generating features that capture patterns in the data;
calculating probability scores for anomaly detection; and
comparing the probability scores against defined thresholds to identify anomalies.

11. The method of claim 10 wherein generating features that capture patterns in the data comprises:
calculating average values and deviations for numerical data fields.

12. The method of claim 10 wherein calculating probability scores for anomaly detection comprises:
using the trained machine learning model's probability output to determine likelihood of anomalies.

13. The method of claim 10 wherein the defined thresholds classify anomalies into risk levels comprising low, medium and high risk.

14. The method of claim 1 wherein analyzing the detected anomalies using Shapley Additive Explanations (SHAP) values comprises:
initializing a TreeExplainer for the Random Forest model;
calculating SHAP values for each feature in the anomalous record;
generating force plots showing feature-level contributions; and
creating summary plots visualizing overall feature impacts on the model output.

15. The method of claim 1 wherein analyzing the detected anomalies using Shapley Additive Explanations (SHAP) values comprises:
calculating SHAP values to determine relative contribution of each feature to anomaly detection.

16. The method of claim 1 wherein analyzing the detected anomalies using Shapley Additive Explanations (SHAP) values comprises:
calculating feature importance rankings from the Random Forest model;
analyzing SHAP values to determine feature contributions;
comparing anomalous values against historical patterns; and
identifying specific attributes and thresholds that triggered the anomaly.

17. The method of claim 1 wherein validating quality of the source data comprises:
comparing patterns in the source data against patterns learned from the historical data.

18. The method of claim 1 wherein maintaining application continuity comprises allowing applications to operate on previously validated data while new data is being processed.

19. A system comprising:
at least one processing device comprising a processor coupled to a memory;
the at least one processing device being configured:
to receive, by an Extract, Transform, Load (ETL) anomaly detection system, source data for processing through an ETL pipeline;
to detect, by the ETL anomaly detection system, anomalies in the source data using a trained machine learning model, wherein the trained machine learning model comprises a Random Forest classifier with multiple decision trees, a feature engineering pipeline that calculates average prices by product model and price deviations, a probability threshold of 0.5 for anomaly classification, and risk level categorization based on probability scores above 0.75 for high risk and between 0.5-0.75 for medium risk;
to analyze, by the ETL anomaly detection system, the detected anomalies using Shapley Additive Explanations (SHAP) values to determine contributing factors to the anomalies;
to validate, by the ETL anomaly detection system, quality of the source data based on the detected anomalies and SHAP analysis, wherein validating the quality of the source data based on the detected anomalies and SHAP analysis occurs before the source data reaches the target system; and
to load, by the ETL anomaly detection system, validated data into a target system while maintaining application continuity, and wherein, when anomalies are detected, data is quarantined rather than loaded into the target system.

20. A computer program product comprising a non-transitory processor-readable storage medium having stored therein program code of one or more software programs, wherein the program code when executed by at least one processing device causes said at least one processing device:
to receive, by an Extract, Transform, Load (ETL) anomaly detection system, source data for processing through an ETL pipeline;
to detect, by the ETL anomaly detection system, anomalies in the source data using a trained machine learning model, wherein the trained machine learning model comprises a Random Forest classifier with multiple decision trees, a feature engineering pipeline that calculates average prices by product model and price deviations, a probability threshold of 0.5 for anomaly classification, and risk level categorization based on probability scores above 0.75 for high risk and between 0.5-0.75 for medium risk;
to analyze, by the ETL anomaly detection system, the detected anomalies using Shapley Additive Explanations (SHAP) values to determine contributing factors to the anomalies;
to validate, by the ETL anomaly detection system, quality of the source data based on the detected anomalies and SHAP analysis, wherein validating the quality of the source data based on the detected anomalies and SHAP analysis occurs before the source data reaches the target system; and
to load, by the ETL anomaly detection system, validated data into a target system while maintaining application continuity, and wherein, when anomalies are detected, data is quarantined rather than loaded into the target system.
